(19) United States
(12) Patent Application Publication
(10) Pub. No.: US 2025/0146192 A1
(43) Pub. Date: May 8, 2025

(54) Manufacturing Woven Textile Products on Demand

(71) Applicant: UNSPUN, INC, San Francisco, CA (US)

(72) Inventors: Stephen E. THOMA, San Francisco, CA (US); Oras PHONGPANANGAM, San Francisco, CA (US); Kevin P. MARTIN, San Francisco, CA (US); Brian J. GORMLEY, San Francisco, CA (US)

(73) Assignee: UNSPUN, INC, San Francisco, CA (US)

(21) Appl. No.: 18/834,107

(22) PCT Filed: Jan. 31, 2023
(86) PCT No.: PCT/US2023/011979

§ 371 Date: Jul. 29, 2024

Related U.S. Application Data
(60) Provisional application No. 63/304,963, filed on Jan. 31, 2022.

(51) Int. Cl. D03D 37/00; D03D 1/00; G05B 15/02

(52) U.S. Cl. CPC D03D 37/00; D03D 1/00; G05B 15/02

(57) ABSTRACT

An overall process of providing information needed for a circular loom to produce articles of clothing on demand is disclosed. Initially body data or measurements are generated for a person by scanning with a camera or other image capture device or estimated based on user-input body parameters. Measurements are extracted from the body data which are then processed with linear regression and other parameter extraction techniques. The extracted measurements are then processed. The resulting panel shapes are used to automatically produce the article of clothing as woven output with the loom.

### CROSS REFERENCE TO RELATED APPLICATIONS

This application claims the benefit of U.S. Provisional Application No. 63/304,963 titled “Manufacturing Woven Textile Products on Demand” and filed on Jan. 31, 2022, which is incorporated herein by reference.

### TECHNICAL FIELD

The present invention is in the technical field of manufacturing woven textile products and, more particularly, to producing desired garments on demand.

### BACKGROUND

The production of textiles and garments has changed little over time. Garments are generally produced in mass quantities, stored in warehouses and then transported to clothing stores for display. Numerous different sizes of each type of garments have to be stored and displayed to fit the different sizes of the various people shopping in the clothing stores. Clothing manufacturers and sellers simply estimate how many articles of each size of clothing will be sold and produce that amount of clothing. Storage of clothing has an associated cost and when manufacturers produce the wrong amount of clothing, sales are lost due to a lack of desirable sizes of clothing and excess inventory of clothing may remain unsold. Excess inventory is often discarded in landfills or incinerated, creating substantial environmental harms.

Woven textiles have several advantages over knitted textiles. For example, woven textiles tend not to stretch out of shape. Woven textiles also tend to be thinner. In addition, woven textiles are lighter because less yarn is required to cover the same area. However, one disadvantage of woven textiles versus knitted textiles is that creating a three-dimensional final woven product generally requires stitching together several distinct woven textile pieces. For many years, manufacturers relied on producing clothing by “cut and sew” techniques. Production of woven garments involved the multi-step process of weaving raw fabric sheets, cutting fabric into panels, and sewing the panels into three-dimensional garments. Stitching two distinct woven textiles together forms a seam. Different distinct woven textiles, and thus seams, are typically needed where the product changes dimension or adds a new part.

When different pieces of fabric are cut and sewn together, a certain amount of fabric will be wasted. Often at least 15% of flat woven fabric is discarded during the cutting operation. Additionally, cutting and sewing fabrics is typically an expensive manual process. With this in mind, there is an advantage in making seamless garments in the garment manufacturing industry in order to reduce both material and labor costs, and to leverage economies of scale.

To address some of these issues, a system and method for producing three-dimensional garments using a variable diameter circular loom has been developed as described in US Patent application entitled “MANUFACTURING WOVEN TEXTILE PRODUCTS”, filed on an even date herewith (Attorney docket number UNS003P) and incorporated herein by reference.

However, there still exists a need in the art for a way to produce garments on-demand to eliminate waste. There also exists a need to eliminate waste from cutting patterns and reduce production time and other costs associated with cut and sew production processes.

### SUMMARY OF THE INVENTION

The present invention is directed to a system and method for measuring size parameters of a person and then producing woven fabric products, on demand, by weaving clothing that is specifically made to fit the person.

More specifically, the method involves receiving body data to determine the shape and size of the person who will be wearing the woven fabric products. The body data is preferably produced by cameras or other digital imaging equipment in the form of three-dimensional body scan data. For example, an iPhone or a 3D scanning booth could be employed. Estimated body data is also obtained from existing video or pictures. Estimated body data can also be generated from user-input metrics such as height and weight. Once the body data is recorded, the data is then transferred to a computer or other electronic processing equipment. The next step is extracting body-shape defining measurements of a portion of the body of interest from the body data. For example, measurements of the legs of the body could be extracted when weaving trousers. Analysis of the body-shape defining measurements is conducted with a fitment engine in the computer to create a fitment for an article of clothing based on fitment metrics. The fitment is converted to a set of computer-readable instructions for manufacturing of the article of clothing. The instructions are then passed to a circular loom for weaving of the fabric product. Alternatively, the instructions and associated data are passed to a flat loom or a fabric cutting machine.

The weaving is conducted with a loom comprising a weaving ring having a diameter that is varied during production of the clothing. Independently actuated heddles are employed to further control the weaving process. Each of the heddles includes an actuator for moving the heddle. The heddles are modular, and each heddle can be replaced as needed for repair or other reasons. Shuttles are provided with a bobbin to support a weft yarn and a weft insertion arm is attached to each shuttle.

This approach allows for the continuous weaving of fabric whose diameter varies along the length of the output, enabling the direct weaving of components of garments (i.e., single pant legs, shirt sleeves, dresses, etc.) from the set of computer readable instructions. The system can also be used to produce bifurcated outputs which would allow for the direct weaving of complete garments. This approach to textile manufacturing is analogous to 3D printing.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

The disclosure may be more completely understood in consideration of the following description of various illustrative embodiments in connection with the accompanying drawings.

FIG. 1 is a perspective view of a loom in accordance with a preferred embodiment of the invention.

FIG. 2 is a top view of the loom shown in FIG. 1.

FIG. 3 is a schematic drawing of the controller for the loom shown in FIG. 1.

FIG. 4 is a diagram showing information flow in the controller of FIG. 3.

FIG. 5 shows a flow chart for the overall process of producing garments on demand according to a first embodiment of the invention.

FIG. 6 shows a flow chart depicting the details of the parametric pants model shown in FIG. 5.

FIG. 7 shows a flow chart for the overall process of producing garments on demand according to a second embodiment of the invention.

### DETAILED DESCRIPTION OF PREFERRED EMBODIMENTS

The following detailed description should be read with reference to the drawings in which similar elements in different drawings are numbered the same. The detailed description and the drawings, which are not necessarily to scale, depict illustrative embodiments and are not intended to limit the scope of the disclosure. Instead, the illustrative embodiments depicted are intended only as exemplary. Selected features of any illustrative embodiment may be incorporated into an additional embodiment unless clearly stated to the contrary. While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### Definitions

As used throughout this application, the singular forms “a”, “an” and “the” include plural forms unless the content clearly dictates otherwise. In addition, the term “or” is generally employed in its sense including “and/or” unless the content clearly dictates otherwise.

“Yarn” refers to any string-like input to the weaving process. Yarn is a generic term for a continuous strand of textile fibers, filaments, or material in a form suitable for knitting, weaving, braiding, or otherwise intertwining to form a textile fabric and is often used interchangeably with “threads” and “lines.”

“Weave” refers to a system, or pattern of intersecting warp and filling yarns. The term, “weave”, is used to describe a large area of textiles that are not knitted or are non-woven fabrics. Plain, twill, and satin are all types of weaves.

“Weft and warp” are terms that refer to the constituent yarns within a weave. The warp yarns run longitudinally to the direction of production while the weft yards run latitudinally to the direction of production and are sometimes called, “filling yarns”.

“Heddles” refers to a structure usually shaped as a loop or eyelet that is able to control the movement (shedding) of the warp yarns. The specific construction of a heddle can vary within different machines.

“Shed” refers to a temporary separation between upper and lower warp yarns and is often used interchangeably with “warp shed.” A warp shed is also a triangularly shaped opening formed in the warp lines as the heddles move. The term also is often used as a verb to describe the action of the upper and lower warp yarns switching positions.

A “shuttle” is a movable loom component that acts as a carriage for the weft line and travels through the warp shed to deposit the weft line.

“Weft insertion” refers to the act of inserting weft into a weave usually via a shuttle with a weft bobbin.

“Weft insertion point” refers to a point set radial distance away from the weaving ring, where the weft is deposited.

### The Loom

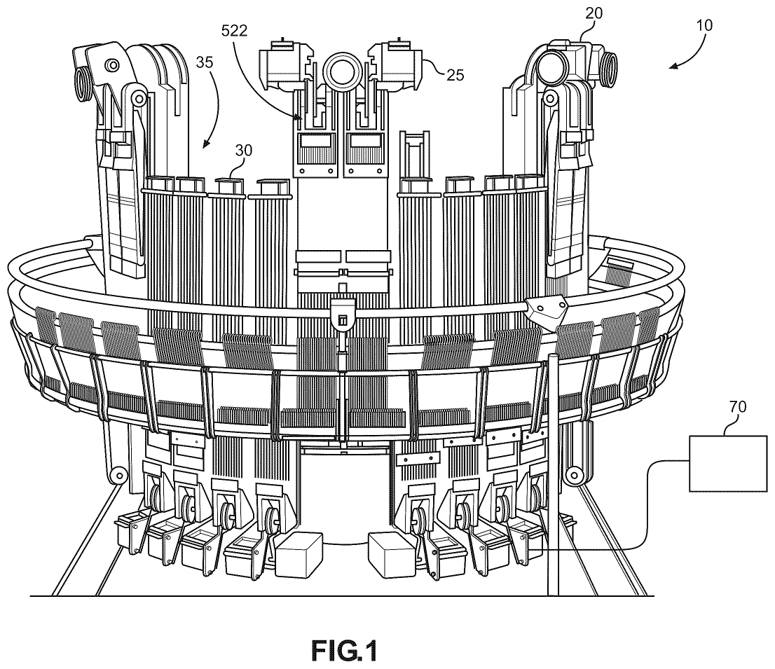

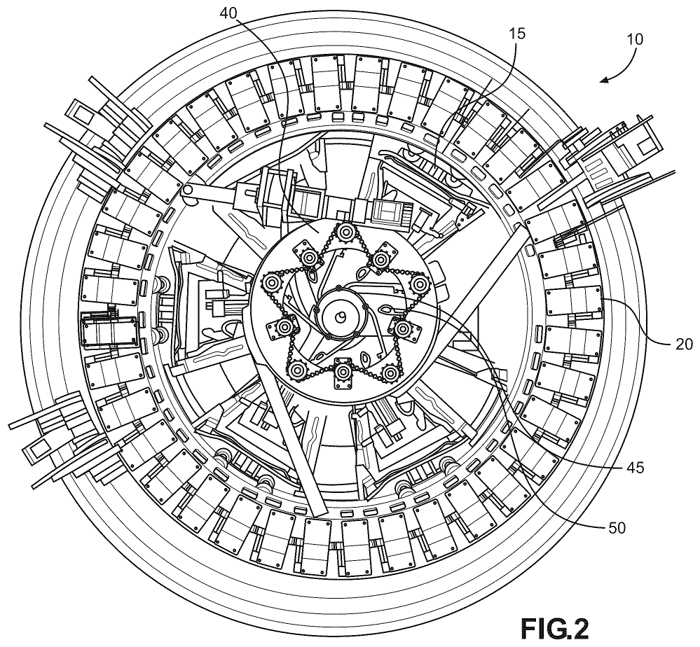

FIG. 1 shows a perspective view of a loom 10 constructed in accordance with a preferred embodiment of the invention. Loom 10 is a circular loom which can be thought of as a series of flat looms arranged in a circle. The operating principles are generally the same as a flat loom, with the major difference lying in the continuous travel of one or more shuttles 15, one of which is labelled in FIG. 2, which depicts a top view of loom 10. In the embodiment depicted, loom 10 has six shuttles 15, of which four are shown. Due to the circular shape of loom 10, during operation, shuttles 15 will pass by heddle units 20. As one of shuttles 15 exits a warp shed of one of heddle units 20, the shuttle 15 will enter the warp shed of an adjacent heddle unit 20. Some of heddle units 20 are upright (such as at 25 in FIG. 1) while some are positioned upside down (such as at 30). Upside down heddle units 30 provide a space 35 for an operator to access an inner portion of loom 10. While not shown in FIG. 1, all heddle units 20 could be mounted upside down and such an arrangement is considered preferable. Heddle units 20 are adjustable. Although not shown in FIG. 1, a supply of yarn is provided to heddle units 20 during operation of loom 10.

With reference to FIGS. 1 and 2, loom 10 includes a variable diameter weaving ring 45 (FIG. 2) and a plurality of variable position weft insertion arms 50, with one weft insertion arm being positioned on each shuttle 15. Loom 10 also includes a system of individually actuated heddle units 20 all controlled by controller 70 or a dedicated heddle control board 522 (FIG. 1). Preferably loom 10 has 36 individually actuated heddle units 20 and each heddle unit has twenty individual heddles of which only eighteen are used during weaving. However, if loom 10 is made larger many more heddle units would preferably be provided and there would preferably be more heddles per unit. Preferably, loom 10 has six weft insertion shuttles 15, four of which are shown in FIG. 2, and one variable diameter weaving ring 45.

More details of loom 10 are described in US Patent application entitled “MANUFACTURING WOVEN TEXTILE PRODUCTS”, filed on an even date herewith (attorney docket number UNS003) and incorporated herein by reference.

### Control System

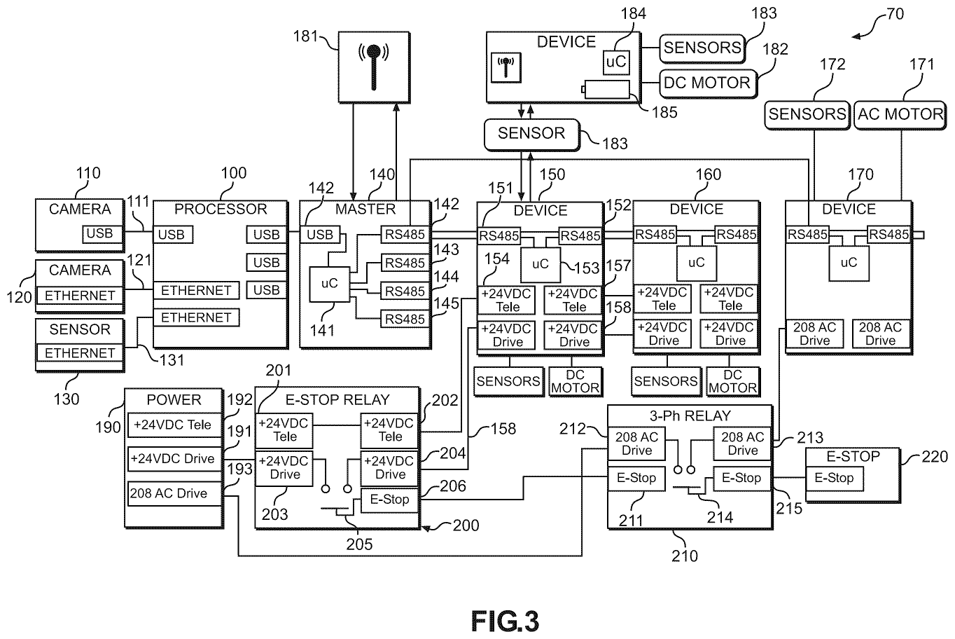

Turning to FIG. 3, there are shown details of control system 70. A control processor 100 runs in real time. Control processor 100 receives information about loom 10 from numerous sources. For example, a camera 110 is shown as connected to control processor 100 by a universal serial bus connection (USB) 111. Another camera 120 is connected to processor 100 by an ethernet connection 121 and a sensor 130 is also shown connected to processor 100 by an ethernet connection 131. The cameras 110, 120 are not necessary and other sensors may be employed in their place. Control processor 100 is also connected to several master controllers, such as master controller 140 which has a microprocessor 141 and several communication ports, e.g., USB port 142 and serial ports 143, 144 and 145 which are designed to employ a communications protocol such as RS485 and preferably can handle high speed data transmission. The master controllers include such devices as USB controllers, translators, Ethernet controllers, etc. Master controller 140 is connected serially to several devices which are preferably motor controllers, input/output controllers, weft controllers, etc. Master controller 140 is also connected to a wireless module which can communicate wirelessly to several devices which are preferably motor controllers, input/output controllers, weft controllers, etc. With particular reference to device 150, device 150 includes serial communication ports 151 and 152 for communication with master controller 140 and other devices. A central processing unit 153 provides device 150 processing capability. Device 150 can also be connected to DC motors and sensors. Also provided are power ports 154, 155, 156 and 157 which form network 158 to link and power other devices. Several additional sensors or cameras could be added to control system 70. For example, encoders, load cells, linear potentiometers, weft break sensors, warp break sensors are preferably connected to devices 150, 160, and 170. These are connected over a variety of digital interfaces including I2C, UART, Modbus and SPI. These devices 150, 160, and 170 are also configured to operate AC motors 171 and communicate with sensors 172, as indicated by device 170. Devices 150, 160, and 170 also communicate wirelessly with the Master controller via wireless module, as indicated by device 180 through a wireless connection 181. Wireless device 180 contains on-board battery power 182 can control a dc motor and can communicate directly with other devices with various sensors 183. Device 180 also has a microcontroller 184. While only four devices 150, 160, 170 and 180 are shown, numerous other, correspondingly constructed devices are located in control system 70.

A power source 190 includes a direct current (“DC”) power port 191 and a DC power communication port 192, along with an alternating current (“AC”) power port 193. DC power travels to an emergency stop relay 200 which includes DC communication ports 201 and 202, DC power ports 203 and 204 and a stop switch 205 that is arranged to stop DC power, when activated. Stop switch 205 is connected by a communication port 206 to a three-phase relay 210. Three-phase relay 210 includes a communications port 211 connected to communication port 206, two AC power ports 212 and 213 and a stop switch 214 connected to a communication port 215. Communication port 215 is connected with an emergency stop switch 220. Stop switch 220, when activated, functions to stop both AC and DC power to all the devices.

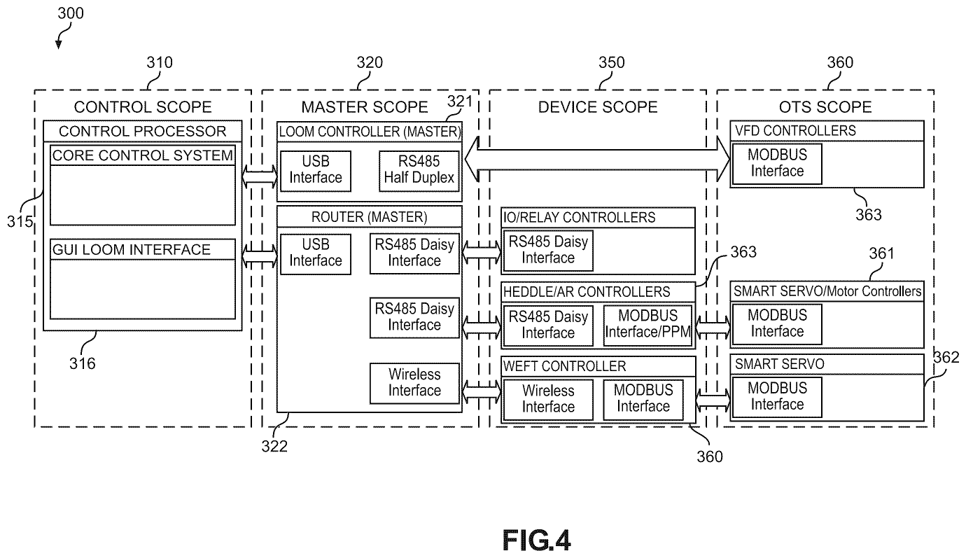

Turning now to FIG. 4, there is shown a control overview for loom 10. Since control of loom 10 occurs in real time, loom control system 70 requires real time measurements taken from various parts of loom 10 in order to institute a feedback control system. The measurements are stored as variables, some of which need to be updated rapidly and some that do not. To achieve real time control, loom control system 70 follows a control scope 300 that defines how often or how quickly variables, used to control loom 10, are updated. A main control scope 310 has components such as a core control system 315 including a weft and warp tension control loop and a Graphical User Interface (“GUI”) 316. Different aspects of loom 10 may be controlled at different levels. For example, the warp tension control may be implemented on the master control level 320, resulting in a faster update. Also, the main control scope 310 has various programs which interface with loom users using high level commands. The high-level commands are updated at a relatively low rate such as with a 200 Hz control loop. At a master control level 320, which includes items such as a loom controller 321 and routers 322, commands are considered medium level commands and are updated at a quicker rate and employ a 2 kHz control loop. Master control level 320 may also include warp tension control which otherwise would be grouped within the main control scope 310, as discussed above. At the lowest level, device scope level 350 commands are updated with a 20 kHz loop. Such devices include input output relay controllers, annular ring controllers, heddle controllers, and weft controllers. Additional devices 360 and controllers are also part of loom control system 70. For example, smart servo motor controllers 361 and 362 may be employed for heddle control 363 or weft insertion 364 and such controllers are updated at the same rate as associated devices. VFD controllers 363 would update with master loom controller 321.

### Process of Producing Garments

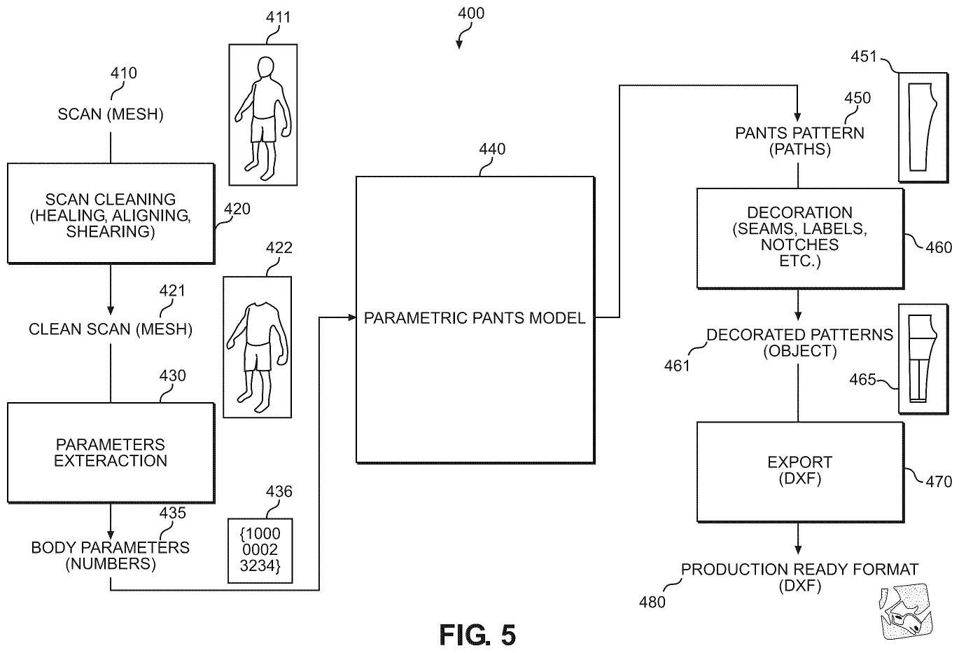

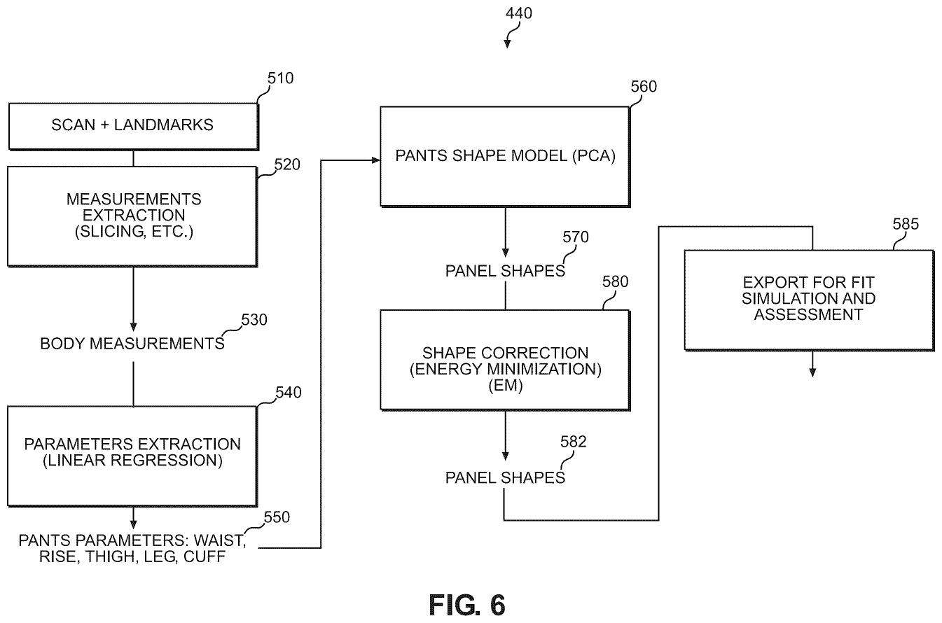

FIG. 5 shows how a parametric pipeline 400 is employed in manufacturing of clothing or apparel, specifically pants for purposes of this example. The process starts with a scan 410 of a person who will be wearing the pants being produced. The scan produces a three-dimensional mesh 411 that is then processed. Scanned mesh 411 is aligned and sheared at 420. Some parts of the mesh are not needed for producing pants and are removed to produce a clean scan 421 with unnecessary features removed 422. Next, the two-dimensional parameters are extracted at 430 from three-dimensional mesh data to create body parameters 435 which are in numerical form at 436. A parametric pants model is used to process (at 440) the body parameters to form pants patterns 451. The model is discussed in more detail with reference to FIG. 6 as discussed below. The parametric designs can be hand crafted, generated from rules-based algorithms, or produced by machine learning algorithms. The hand-crafted designs are inspired by traditional pattern making where one must manually select body and pants measurements. By contrast, rules-based designs are processed automatically, with pants measurements being defined by geometric relations and body measurement offsets. Finally, machine learning designs are processed by automatically selecting and learning parameters based on pants designed in previous attempts. Such machine learning preferably incorporates principal component analysis and processes the designs with neural networks. The advantage of employing artificial intelligence techniques, such as machine learning neural networks, is that the process is simplified, easy and faster to run. Such a process can be altered by adding constraints to the machine learning process. For example, the machine learning process can be required to produce patterns that are easily sewn; can learn from prior attempts; and can provide suggestions on modifying current process. After that, decoration is added at 460, such as seams, labels and notches etc. This step produces decorated patterns 465 which can be exported at 470 in a DXF production ready format 480 used to have loom 10 produce pieces of clothing used to form decorated patterns 465.

FIG. 6 shows a flow chart of the Parametric Pants Model 440 from FIG. 5. As discussed above, a person is scanned by a camera or other type of image capture device to obtain a three-dimensional scan in the form of points defining a three-dimensional surface. The scan is designed not only to obtain an overall shape of the person, but also to highlight landmarks on the person's body. The results of the scan and the landmarks are input into the model 440 at step 510.

Next, at 520, measurements are extracted from the three-dimensional scan to obtain body measurements 530. The extraction is conducted by slicing the three-dimensional scan into two-dimensional slices and through other processing techniques. Body measurements 530, which constitute the three-dimensional measurements of portions of the body that are of interest are then processed, at 540, with linear regression and other parameter extraction techniques. When linear regression is employed, an automated guess is made regarding a required amount of bias and easing based on the production of prior pants. As an example, pants parameters are extracted. As a formula, the linear regression preferably starts with, “PantsParams=Measurements*Coefficient1+Coefficient2” or for example, Seatline=Hips*0.5+20. The extracted pants parameters 550 are measurements on two-dimensional panels. Pants parameters include waist, rise, thigh, leg and cuff measurements, although additional parameters, or fewer parameters may be employed.

Parameters 550 are then processed at 560 with a fitment engine or shape model using principal component analysis. The important features are automatically extracted for a set of shapes. Related parts of the panels are morphed together to give natural looking shapes. Also, principal component analysis reduces the number of dimensions needed for a machine learning model. A shape model or fitment for an article of clothing is chosen based on the clothing desired and panel shapes are produced with the model based on the measurements. Again, as an example, a pants shape model could be employed to form panel shapes 570 associated with a pair of pants.

Panel shapes 570 are then processed by a shape correction algorithm at 580. If a model or algorithm is used to make a prediction, the difference between the model's prediction and the outcome is classified as “energy”. In one example, the energy required by the learning models could be minimized. Other improvements include for instance, the seam lengths could be reduced, bumpy seams could be eliminated, and the lengths of the various parameters could be set closer to their final target lengths. Panel shapes 582 are then exported at 585 for virtual fit simulation and assessment. Panel shapes are adjusted according to the virtual fit assessment before being exported to 560 for decoration. The panels are then equivalent to pants pattern 450 from FIG. 5, which eventually are exported as DXF files at 480 and used in cut and sew fabrication methods.

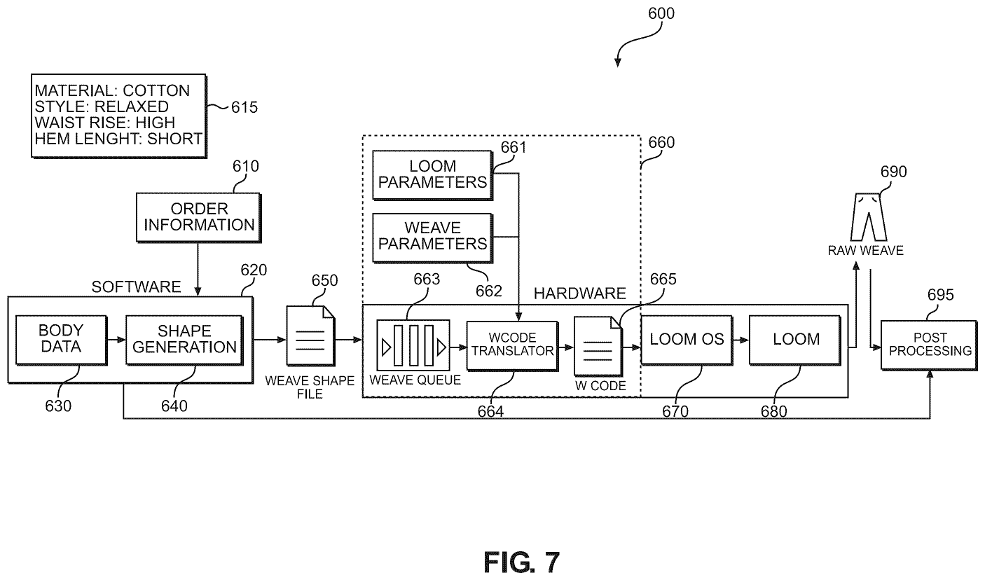

FIG. 7 shows a pipeline or process 600 for data flow from the starting body data 630 all the way to loom output. The body data is preferably produced by cameras or other digital imaging equipment in the form of three-dimensional body scan data. Estimated body data is also obtained from existing video or pictures. Estimated body data can also be generated from user-input metrics such as height and weight. Process 600 starts with order information 610 which includes details 615 such as the material, style, and dimensions. Process 600 includes software 620 that receives body data 630 of a person who will be wearing the pants being produced. A shape generation algorithm 640 then extracts useful measurements from the body data 630, and in combination with the provided order information 610, produces weave shape data preferably in the form of a weave shape file 650. Examples of order information details 615 may include, but are not limited to customer ID, material, fit, preference and style information. Fit information may include typical pant fits such as slim, relaxed, or loose, while style information can include waist rise and hem length. The output weave shape data or file 650 is in a human readable format, similar to an XML or YAML file, and is generic enough to not include any loom specific commands. Alternatively, weave shape file 650 can be structured data stored in a database and accessed via an API for processing.

Next, at 660, loom parameters 661, weave parameters 662 and weave shape data or file 650 are all processed. Specifically, weave shape file 650 is added to a weave queue 663 where it may be grouped with other weave files according to a plurality of metrics. Weave files may be queued according to factors such as material, shape, style, or order of receipt. A WCode translator 664 then takes as input weave shape data/files from the weave queue, loom parameters 661, and weave parameters 662. The queueing and WCode 665 generation preferably occur on a remote computer, cloud server, or local computer. Loom parameters 661 may include loom specific attributes such as the number of available warp lines or gear ratios of the loom's motors. Weave parameters 662 may include loom-agnostic parameters such as desired speed or weaving density. Weave parameters 662 may be constrained by physical limitations imposed by loom parameters.

WCode translator 664 is a module that interprets simple dimensional aspects of a weave defined in the weave shape data/file and converts it to the appropriate set of WCode commands to be read into the loom's operating system. WCode translator 664 also verifies that the desired shape can be woven on a specific loom and will report an error if it is not possible.

WCode 665 is a set of computer-readable instructions that defines control parameters for the loom. As opposed to the weave shape file 650, which gives a high-level description of the output of the weave, the WCode file 665 allows for finer control over loom parameters such as warp tension, motor speeds, and weave pattern.

Finished WCode 665 is then provided to a given loom's operating system 670, which preferably runs on a processor, such as processor 100 described above with regard to FIG. 3. Operating system 670 then directs loom 680, which could be loom 10 discussed above, to produce a woven output 690 in accordance with the instructions dictated in the WCode 665. Multiple outputs may be produced sequentially before being removed from the loom 680 and post-processed at 695. The post-processing step 695 prepares woven outputs 690 to become usable products, and may include the addition of buttons, zippers, or other steps not included in the weaving process 600.

Based on the above it should be readily apparent that the subject method is able to produce production ready formats representing clothing which can then be produced by the loom. As a result, the loom can directly weave components of garments such as single pant legs, shirt sleeves, dresses etc., based on body data of the person who will wear the clothes. In some cases, complete garments may be directly woven on demand for an exact fit to the body data of a person.

1. A method for manufacturing apparel, comprising:
receiving body data;
producing weave shape data based on the body data, wherein producing the weave shape data includes combining order information details with the received body data; and
automatically producing a woven article of clothing on a variable diameter circular loom based on the weave shape data, with the weave shape data being translated into computer-readable instructions that define control parameters for the loom.

2. The method of claim 1, wherein producing the weave shape data includes:
extracting body-shape defining measurements of a portion of a body of interest from the body data;
analyzing, via a fitment engine, body-shape defining measurements to create a fitment for an article of clothing based on fitment metrics; and
outputting a set of computer-readable instructions for manufacturing of the woven article of clothing, wherein the woven article of clothing is automatically produced based on the set of computer readable instructions on the variable diameter circular loom.

3. The method according to claim 2, wherein receiving the body data includes taking a picture of the portion of the body of interest and highlighting landmarks on the body of interest.

4. The method according to claim 2, wherein receiving the body data includes taking a three-dimensional body scan.

5. The method according to claim 2, wherein receiving the body data includes generating body data from user-input metrics.

6. The method according to claim 2, wherein extracting body-shape defining measurements includes employing linear regression on the measurements.

7. The method according to claim 2, wherein analyzing the body-shape defining measurements includes conducting principal component analysis to reduce a number of dimensions in the measurements and then applying machine learning techniques on the measurements.

8. The method according to claim 2, wherein analyzing the body-shape defining measurements includes forming panel shapes from the measurements and processing the panel shapes with a shape correcting algorithm.

9. (canceled)

10. The method according to claim 1, wherein order information details includes at least one of customer ID, material, fit, preference, or style information.

11. (canceled)

12. The method according to claim 1, wherein producing the computer-readable instructions includes combining loom parameters with the weave shape data.

13. The method according to claim 1, wherein producing the computer-readable instructions includes combining weave parameters with the weave shape data.

14. The method according to claim 12, wherein loom parameters includes number of available warp lines.

15. The method according to claim 12, wherein loom parameters includes gear ratios of loom motors.

16. The method according to claim 13, wherein weave parameters includes desired speed.

17. The method according to claim 13, wherein weave parameters includes weaving density.

18. The method according to claim 1, wherein multiple woven outputs are produced sequentially.

19. The method according to claim 1, wherein the body data is a three-dimensional body scan.

20. The method according to claim 1, wherein the body data is generated from user-input metrics.

21. The method according to claim 1, wherein the body data is generated from a two-dimensional video or picture.
